(19) United States
(12) Patent Application Publication
(10) Pub. No.: US 2007/0089950 A1
(43) Pub. Date: Apr. 26, 2007

(54) Shock absorber for vehicle

(76) Inventor: Se Bum Kim, Ulsan-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/323,453

(22) Filed: Dec. 30, 2005

(30) Foreign Application Priority Data
Oct. 25, 2005 (KR) 10-2005-0100794

(51) Int. Cl. F16F 9/48

(52) U.S. Cl. 188/289; 188/284

(57) ABSTRACT

A shock absorber for a vehicle comprises a cylinder containing oil therein, the cylinder being connectable to one of an axle and a vehicle body, a piston movable within the cylinder to divide the interior space of the cylinder into a first chamber and a second chamber, the piston having a plurality of oil holes perforated therethrough for the passage of the oil, an operating rod having one end fastened to the piston and the other end couplable to the other one of the axle and the vehicle body, and a plurality of area-variation members longitudinally arranged in the cylinder, each used to vary an opening area of an associated one of the oil holes in accordance with a position of the piston.

### CROSS-REFERENCE TO RELATED APPLICATION

This application claims priority to and the benefit of Korean Patent Application No. 10-2005-0100794 filed in the Korean Intellectual Property Office on Oct. 25, 2005, the entire contents of which are incorporated herein by reference.

### BACKGROUND OF THE INVENTION

1. Field of the Invention

The present invention relates to a shock absorber for a vehicle, and, more particularly, to a shock absorber with an oil passage that is variable in accordance with the position of the piston.

2. Description of the Related Art

Generally, a suspension for a vehicle includes at least one suspension spring mounted between an axle and a frame to attenuate shock or vibration applied to a wheel, and a shock absorber to absorb a natural vibration of the spring to improve riding comfort.

In operation of a conventional shock absorber, if shock is transmitted from a wheel, a piston acts to absorb the shock while moving on an inner circumferential surface of a cylinder. As the piston moves downward or upward, oil moves between a first chamber and a second chamber by passing through an oil passage. When the oil passes through the oil passages, the oil is subjected to flow resistance, acting to attenuate the shock.

However, such a shock absorber can have a problem in that it generates a constant damping force even for various strengths of shocks transmitted from a wheel because the area of the oil passage is constant. Therefore, the prior art shock absorber can exhibit poor shock attenuation efficiency.

Specifically, if the shock absorber generates such a constant damping force regardless of whether a high-strength shock or low-strength shock is transmitted from a wheel, the shock absorber may often fail to effectively absorb the shock, resulting in riding discomfort.

Furthermore, it can be said that the constant area of the oil passage is a factor of deferring the restoration rate of the shock absorber. This disadvantageously delays a vehicle in restoring an original state thereof, resulting in deterioration in the restoration property of the vehicle.

### SUMMARY OF THE INVENTION

Embodiments of the present invention provide a shock absorber for a vehicle in which the area of an oil passage is variable in accordance with the position of a piston, whereby, if shock is transmitted to the shock absorber, the area of the oil passage is reduced to obtain a strong damping force, whereas the area of the oil passage is increased during a restoration period after elimination of shock to enable rapid restoration of the vehicle, achieving an improvement in riding comfort.

In accordance with an exemplary embodiment of the present invention, a shock absorber for a vehicle comprises a cylinder containing oil therein, the cylinder being connected to one of an axle and a vehicle body; a piston which is in movable contact with an inner circumferential surface of the cylinder to divide the interior space of the cylinder into a first chamber and a second chamber, the piston having a plurality of oil holes perforated therethrough for the passage of the oil; an operating rod having one end fastened to the piston and the other end coupled to the other one of the axle and the vehicle body; and a plurality of area-variation members longitudinally arranged in the cylinder, each used to vary an opening area of an associated one of the oil holes in accordance with a position of the piston.

Each of the area-variation members may be arranged so that one end thereof is fixed to an upper location of the cylinder and the other end thereof is fixed to a lower location of the cylinder while penetrating through an associated one of the oil holes.

Each of the area-variation members may further have a first section configured to minimize the opening area of an associated one of the oil holes, a second section configured to allow a moderate opening area of the oil hole, and a third section to maximize the opening area of the oil hole.

The first section of the area-variation member may have a largest diameter so that the opening area of the oil hole is minimized when the first section passes through the oil hole, the second section of the area-variation member may be tapered to have a gradual decrease in diameter, and the third section of the area-variation member may have a smallest diameter so that the opening area of the oil hole is maximized when the third section passes through the oil hole.

### BRIEF DESCRIPTION OF THE DRAWINGS

The features and advantages of the present invention will be more clearly understood from the following detailed description taken in conjunction with the accompanying drawings, in which:

FIG. 1 is a sectional view illustrating a shock absorber according to the present invention;

FIG. 2 is a sectional view illustrating the interior of a cylinder provided in the shock absorber according to the present invention; and

FIGS. 3A to 3C are sectional views illustrating the sequential operation of the shock absorber according to the present invention.

### DESCRIPTION OF THE PREFERRED EMBODIMENTS

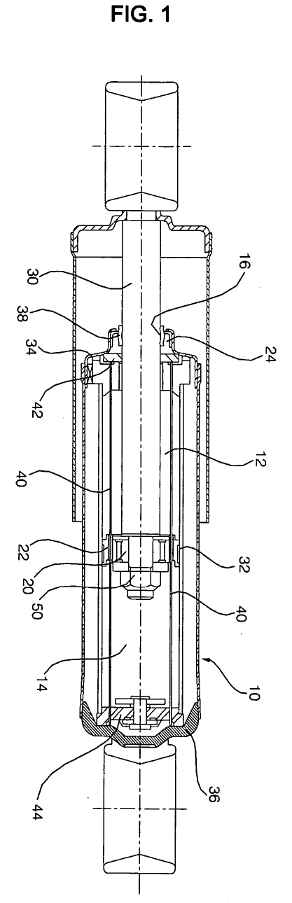

As shown in FIG. 1, a shock absorber according to the present invention comprises a cylinder 10, a piston 20, an operating rod 30 and a plurality of area variation members 40. The cylinder 10 is filled with oil and is coupled to one of a vehicle body and an axle. The piston 20, which is in movable contact with an inner circumferential surface of the cylinder 10, divides the interior space of the cylinder 10 into a first chamber 12 and a second chamber 14. The piston 20 also has a plurality of oil holes 22 perforated therethrough, so that the oil is subjected to flow resistance while passing through the oil holes 22. The operating rod 30 has one end coupled to the piston 20 and the other end coupled to the other one of the vehicle body and the axle. The area-variation members 40 are received in the cylinder 10, each used to vary the opening area of an associated one of the oil holes 22 in accordance with the position of the piston 20.

The cylinder 10 includes a cylindrical body 32 containing the oil therein, a lower cover 36 mounted to a lower end of the body 32 to seal the body 32, the lower cover 36 being coupled to one of the vehicle body and the axle, and an upper cover 38 mounted to an upper end of the body 32 to seal the body 32. The upper cover 38 has a passage 16 for the penetration of the operating rod 30. To prevent oil from leaking through the passage 16 in a state wherein the operating rod 30 penetrates through the passage 16, a sealing member 24 is mounted to the upper cover 38.

A first fixing plate 42 is mounted in the upper end of the cylinder 10, and a second fixing plate 44 is mounted in the lower end of the cylinder 10. The upper and lower ends of the area-variation members 40 are thus coupled to the first and second fixing plates 42 and 44.

The first fixing plate 42 has a disk shape, and is affixed to the upper cover 34. A plurality of coupling recesses 46 are formed in a surface of the first fixing plate 42 along a periphery of the first fixing plate 42, so that the upper ends of the area-variation members 40 are coupled into the recesses 46, respectively.

Similarly, the second fixing plate 44 has a disk shape, and is affixed to the lower cover 36. A plurality of coupling recesses 48 are formed in a surface of the second fixing plate 44 along a periphery of the second fixing plate 44, so that the lower ends of the area-variation member 40 are coupled into the recesses 48, respectively.

The piston 20 is centrally fastened to an end surface of the operating rod 30 by use of a bolt 50, to move along with the operating rod 30. Thereby, in accordance with movement of the operating rod 30, the piston 20 moves along the inner circumferential surface of the cylinder 10 while coming into close contact at an outer circumferential surface thereof with the inner circumferential surface of the cylinder 10. The piston 20 is circumferentially formed with the plurality of oil holes 22 with an equal distance, so that the oil, filled in the cylinder 10, is subjected to flow resistance while passing through the oil holes 22 in accordance with the movement of the piston 20, thereby generating a damping force.

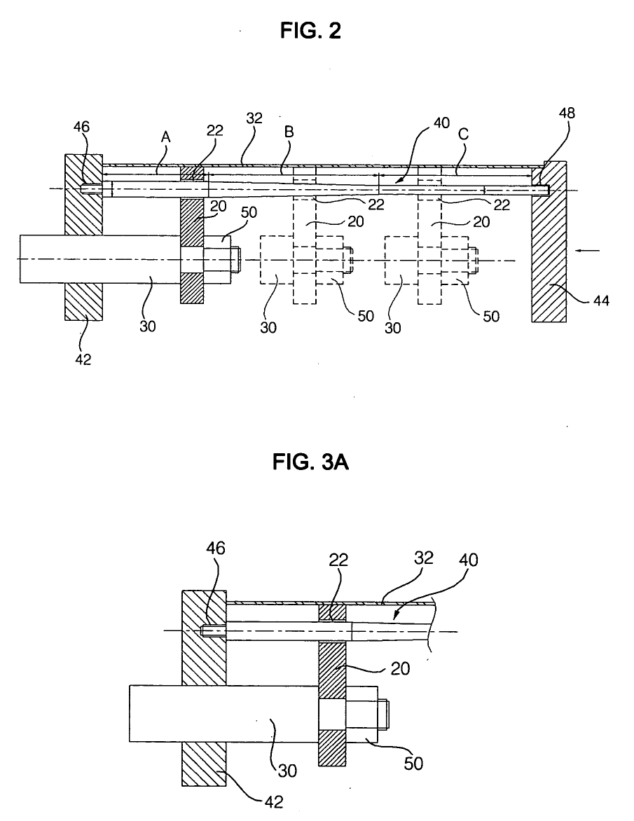

As shown in FIG. 2, each of the area-variation members 40 may take the form of a cylindrical rod having one end coupled to the first fixing plate 42 and the other end coupled to the second fixing plate 44. The area-variation member 40 is divided into several sections having different diameters from each other.

Preferably, the area-variation member 40 has a diameter smaller than that of an associated one of the oil holes 22 so that the area-variation member 40 is smoothly penetrated through the oil hole 22. More preferably, three to six area-variation members 40 are circumferentially arranged in the cylinder 10.

In a further embodiment, the area-variation member 40 may include three sections, i.e. a first section A having a largest diameter, a second section B having a moderate diameter, and a third section C having a smallest diameter. When the first section A having the largest diameter passes through the oil hole 22, the first section A minimizes the opening area of the oil hole 22, thereby restricting the passage of oil via the oil hole 22. As a result, the oil is subjected to a high flow resistance, generating a strong damping force. When the second section B having the moderate diameter passes through the oil hole 22, the second section B ensures adequate normal opening area of the oil hole 22, and when the third section C having the smallest diameter passes through the oil hole 22, the third section C maximizes the opening area of the oil hole 22 to ensure smooth passage of the oil.

Here, the diameter of the first section A of the area-variation member 40 is determined so that the opening area of the oil hole 22 is optimized to generate a strong damping force suitable for an excessive shock transmitted to the shock absorber.

The second section B of the area-variation member 40 is tapered so that the diameter thereof is gradually reduced from the first section A to the third section C. When the piston 20 moves upon receiving shock transmitted thereto, the tapered second section B allows the opening area of the oil hole 22 to be gradually reduced to enable smooth shock absorption. Conversely, when the piston 20 is returned to an original position thereof, the tapered second section B allows the opening area of the oil hole 22 to be gradually increased to enable rapid return.

The diameter of the third section C of the area-variation member 40 is determined to maximize the opening area of the oil hole 22 when the piston 20 is returned to an original position thereof after elimination of shock.

In the present invention, the lengths and diameters of the first, second, and third sections A, B, and C of the area-variation member 40 are determined to have optimal values suitable for various requirements of a vehicle.

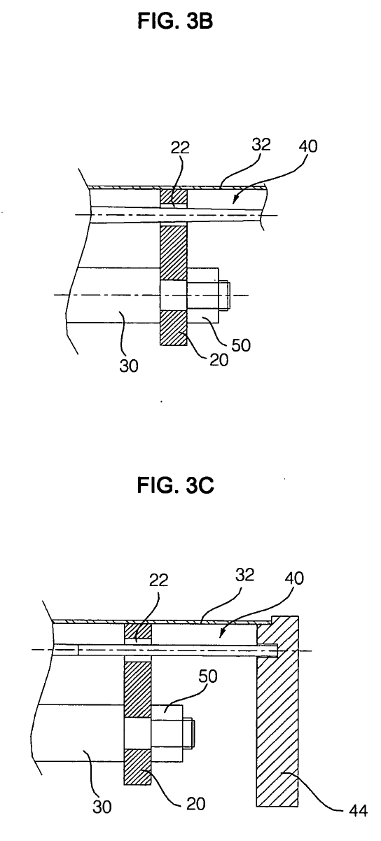

Hereinafter, with reference to FIGS. 3A to 3C, operation of the shock absorber according to an embodiment of the present invention will be explained.

If an excessive shock is transmitted from a wheel, the piston 20 moves upward in the cylinder 10, so that each oil hole 22 of the piston 20 is shifted from the second section B of an associated one of the area-variation members 40 to the first section A thereof. Thereby, the opening area of the oil hole 22 is gradually reduced as the second section B of the area-variation member 40 passes through the oil hole 22 of the piston 20. Consequently, the opening area of the oil hole 22 is minimized when the oil hole 22 of the piston 20 is located at the first section A of the area-variation member 40, causing the oil to confront a high flow resistance. The flow resistance of oil generates a strong damping force for smoothly absorbing the shock, resulting in an improvement in riding comfort.

Conversely, when the piston 20 is returned to an original position thereof after elimination of shock, the oil hole 22 of the piston 20 is shifted to the second section B, so that the opening area of the oil hole 22 is gradually increased. After that, if the oil hole 22 of the piston 20 is located at the third section C of the area-variation member 40, the opening area of the oil hole 22 is maximized. This enables rapid return of the piston 20 and consequently, rapid restoration of a vehicle, resulting in an improvement in riding comfort.

As apparent from the above description, the present invention provides a shock absorber for a vehicle, in which the opening area of an oil hole is minimized when an excessive shock is transmitted from a wheel, so as to generate a high damping force. Conversely, the opening area of the oil hole is maximized after elimination of the shock, so that the vehicle can be rapidly returned to an original state thereof. This has the effect of achieving an improvement in riding comfort.

Although exemplary embodiments of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A shock absorber for a vehicle, comprising:
a cylinder containing oil therein, the cylinder being configured for connection to one of an axle and a vehicle body;
a piston which is in movable contact with an inner circumferential surface of the cylinder to divide the interior space of the cylinder into a first chamber and a second chamber, the piston having a plurality of oil holes perforated therethrough for the passage of the oil;
an operating rod having one end fastened to the piston and the other end configured for coupling to the other one of the axle and the vehicle body; and
a plurality of area-variation members longitudinally arranged in the cylinder, each used to vary an opening area of an associated one of the oil holes in accordance with a position of the piston.

2. The shock absorber as set forth in claim 1, wherein the plurality of oil holes of the piston is equidistantly arranged in a circumferential direction of the piston.

3. The shock absorber as set forth in claim 1, wherein each of the area-variation members is arranged so that one end thereof is fixed to an upper location of the cylinder and the other end thereof is fixed to a lower location of the cylinder while penetrating through an associated one of the oil holes.

4. The shock absorber as set forth in claim 3, wherein the plurality of area-variation members are circumferentially arranged in the cylinder so that the number of the area-variation members is equal to the number of the oil holes of the piston.

5. The shock absorber as set forth in claim 3, wherein each of the area-variation members has a cylindrical rod shape, and is divided into several sections having different diameters from each other.

6. The shock absorber as set forth in claim 3, wherein three to six area-variation members are circumferentially arranged in the cylinder.

7. The shock absorber as set forth in claim 3, wherein a first fixing plate is mounted in an upper end of the cylinder so that upper ends of the area-variation members are coupled to the first fixing plate.

8. The shock absorber as set forth in claim 3, wherein a second fixing plate is mounted in a lower end of the cylinder so that lower ends of the area-variation members are coupled to the second fixing plate.

9. The shock absorber as set forth in claim 3, wherein each of the area-variation members has a first section configured to minimize the opening area of an associated one of the oil holes, a second section configured to allow a moderate opening area of the oil hole, and a third section to maximize the opening area of the oil hole.

10. The shock absorber as set forth in claim 9, wherein the first section of the area-variation member has a largest diameter, so that the opening area of the oil hole is minimized when the first section passes through the oil hole.

11. The shock absorber as set forth in claim 9, wherein the second section of the area-variation member is tapered to have a gradual decrease in diameter.

12. The shock absorber as set forth in claim 11, wherein the third section of the area-variation member has a smallest diameter, so that the opening area of the oil hole is maximized when the third section passes through the oil hole.
